(19) United States
(12) Patent Application Publication
(10) Pub. No.: US 2022/0405631 A1
(43) Pub. Date: Dec. 22, 2022

(54) DATA QUALITY ASSESSMENT FOR UNSUPERVISED MACHINE LEARNING

(71) Applicant: International Business Machines Corporation, Armonk, NY (US)

(72) Inventors: Ramasuri Narayanam, Andhra Pradesh (IN); Hima Patel, Bengaluru (IN); Lokesh Nagalapatti, Chennai (IN); Ruhi Sharma Mittal, Bengaluru (IN)

(21) Appl. No.: 17/353,978

(22) Filed: Jun. 22, 2021

(51) Int. Cl. G06N 20/00; G06N 5/04

(52) U.S. Cl. CPC G06N 20/00; G06N 5/042

(57) ABSTRACT

Techniques for qualitatively assessing unlabeled data in an unsupervised machine learning environment are disclosed. In one example, a method comprises the following steps. A dataset of unlabeled data points is converted into a graph structure. Nodes of the graph structure represent the unlabeled data points in the dataset and weighted edges between at least a portion of the nodes represent similarity between the unlabeled data points represented by the nodes. A metric is computed for each node of the graph structure. A value generated by the metric for a given node represents a measure of dissimilarity between the corresponding unlabeled data point of the given node and one or more other unlabeled data points of one or more other nodes. A subset of the dataset is generated by removing one or more unlabeled data points from the dataset based on one or more values of the computed metric.

### BACKGROUND

Machine learning is a form of artificial intelligence that enables a system to learn from data rather than through explicit programming. There are two main types of machine learning: (i) supervised machine learning; and (ii) unsupervised machine learning.

Supervised machine learning typically starts with an established set of data and a certain understanding of how that data is classified. The set of data has labeled features that define the meaning of the data. Therefore, a goal of supervised machine learning is to learn a function that, given a sample of data and desired outputs, best approximates the relationship between an input and output observable in the data. For example, a machine-learning application can be created that distinguishes between a large number of animals based on images and/or written descriptions.

On the other hand, unsupervised machine learning does not have labeled outputs, so its goal is to infer the natural structure present within a set of data. Thus, unsupervised machine learning is used when the problem requires a large amount of unlabeled data. By way of example only, social media applications have large amounts of unlabeled data. Understanding the meaning behind this unlabeled data requires an unsupervised machine learning algorithm that classifies the data based on the patterns or clusters it finds.

While much effort has been given to improving supervised machine learning, less effort has been given to techniques for improving unsupervised machine learning.

### SUMMARY

Embodiments of the invention provide techniques for qualitatively assessing unlabeled data in an unsupervised machine learning environment.

In one illustrative embodiment, a method comprises the following steps. A dataset of unlabeled data points is converted into a graph structure. Nodes of the graph structure represent the unlabeled data points in the dataset and weighted edges between at least a portion of the nodes represent similarity between the unlabeled data points represented by the nodes. A metric is computed for each node of the graph structure. A value generated by the metric for a given node represents a measure of dissimilarity between the corresponding unlabeled data point of the given node and one or more other unlabeled data points of one or more other nodes. A subset of the dataset is generated by removing one or more unlabeled data points from the dataset based on one or more values of the computed metric.

Further illustrative embodiments are provided in the form of a computer program product comprising a non-transitory computer-readable storage medium having embodied therein executable program code that when executed by a processor causes the processor to perform the above steps. Still further illustrative embodiments comprise an apparatus or system with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates an unlabeled data quality assessment engine and information processing system environment according to an illustrative embodiment.

FIG. 2 illustrates an example portion of a graph with which one or more illustrative embodiments can be implemented.

FIG. 3 illustrates an unlabeled data quality assessment process flow according to an illustrative embodiment.

FIGS. 4A through 4C illustrate metric definition and computation processes according to illustrative embodiments.

FIG. 5A and 5B illustrate improved graph modularity scores utilizing an unlabeled data quality assessment process flow according to one or more illustrative embodiments.

FIG. 6 illustrates an unlabeled data quality assessment process flow according to an illustrative embodiment.

FIG. 7 illustrates an exemplary information processing system according to an illustrative embodiment.

FIG. 8 illustrates a cloud computing environment according to an illustrative embodiment.

FIG. 9 illustrates abstraction model layers according to an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass a wide variety of processing system, by way of example only, processing systems comprising cloud computing and storage systems as well as other types of processing systems comprising various combinations of physical and/or virtual processing resources.

As mentioned above in the background section, unsupervised machine learning has not received the same level of attention with regard to research as supervised machine learning. Nonetheless, there are many use cases for which unsupervised machine learning can be applied.

By way of example only, some exemplary use cases include: (i) building insight about underlying learning tasks; (ii) enabling discovery of corrupted samples; (iii) rendering a learning model effective for domain adoption; (iv) sampling a subset of high valued data points to design approximate solutions; (v) partitioning a dataset without any labels for the dataset; and (vi) setting monetization (e.g., a scenario wherein hospitals with sensitive data participate to build drug discovery models). However, in the above exemplary use cases and other real-world systems, data often exists on the order of gigabytes or petabytes, which causes a large computational load and thus a significant challenge for any existing unsupervised machine learning algorithms.

Illustrative embodiments address the above and other challenges by providing techniques for qualitatively assessing a dataset to identify a subset of data for the dataset that is representative of the dataset, such that the subset of data can be used, for example, to efficiently execute pipelines during a modeling stage of an unsupervised machine learning algorithm without changing the distribution of the original dataset.

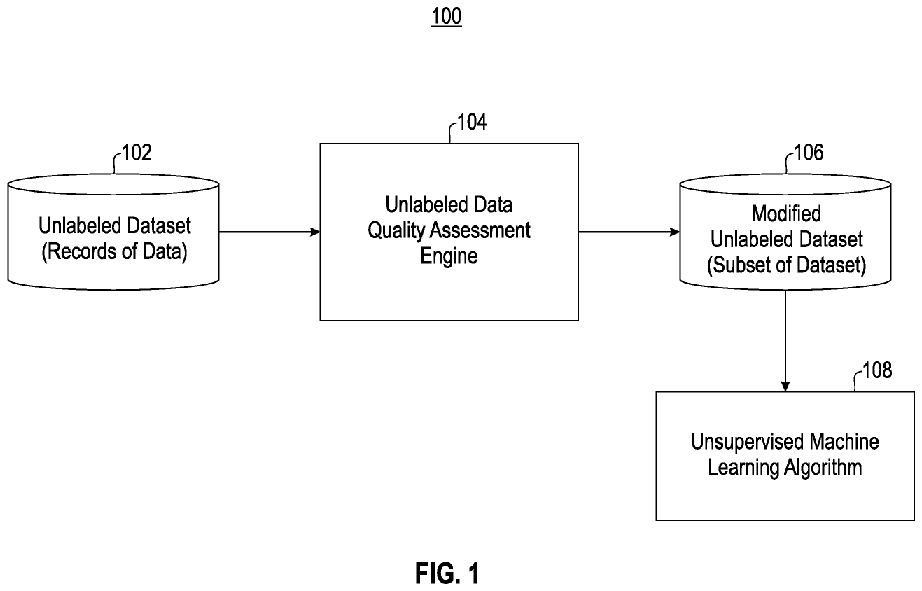

FIG. 1 depicts an unlabeled data quality assessment engine and information processing system environment 100 according to an illustrative embodiment. As shown, an unlabeled dataset (records of data or data records) 102 is input to an unlabeled data quality assessment engine 104. Unlabeled data quality assessment engine 104 processes unlabeled dataset 102 to generate a subset of data 106 for the dataset that is representative of the dataset. As will be further explained in detail herein, a relative value for each record in unlabeled dataset 102 is computed and the set of values is used to prune or modify unlabeled dataset 102 to yield a subset 106 of unlabeled data. The subset of data is then used by an unsupervised machine learning algorithm 108 resulting in an improved measure of performance for the unsupervised machine learning algorithm 108.

In one or more illustrative embodiments, as will be further explained herein, the data records (also alternatively referred to herein as data points) are modeled as a graph structure. Each node (vertex) of the graph structure represents a data point. In a typical graph-based representation, a weighted edge is connected between some or all pairs of data points wherein the weight is a measure or score of similarity between the two corresponding data points. The score may typically need to be above a predetermined threshold value for there to be an edge included in the graph structure.

More particularly, one or more illustrative embodiments capture the value of each unlabeled data point or record by measuring the extent to which that data point connects with a distinct and/or diverse individual data point or a collections of distinct and/or diverse data points. As referred to illustratively herein, the terms “diverse,” “distinct,” “distinct diverse” and the like can be used interchangeably and refer to the degree of dissimilarity between pairs of data points. That is, points identified as such are unique (distinct) and/or the diversity of a selected set of nodes is high (diverse). The degrees or levels of uniqueness and diversity can be predefined based on the given data application involved. Thus, as realized herein, two data points with relatively high similarity are together no more valuable to a machine learning algorithm than one of the two data points since one of them is sufficient to convey the information contained in the other data point. In other words, in one or more illustrative embodiments, the information gained by collecting diverse (i.e., highly dissimilar) data points is maximized. In a graph-based representation of data points, the notion of value for data points (i.e., nodes in the graph) can be captured by measuring the extent to which that node connects with a distinct individual node or one or more well-knit groups of distinct nodes, as will further be explained herein.

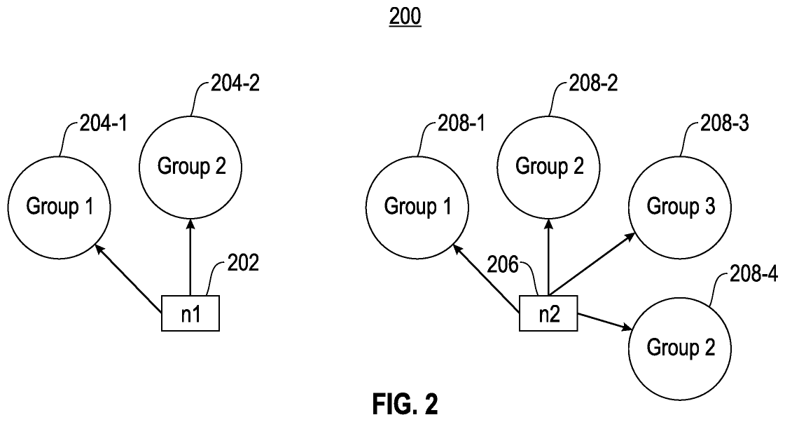

Referring to FIG. 2, an example portion of a graph 200 is depicted according to an illustrative embodiment. More particularly, to illustrate one illustrative notion of value of a data point, graph 200 depicts an example where one data point is considered more valuable than another data point. As shown, data point 202 (graphically represented as node n1) connects with two groups of nodes including group 204-1 (Group 1) and group 204-2 (Group 2), while data point 206 (graphically represented as node n2) connects with four groups of nodes including group 208-1 (Group 1), group 208-2 (Group 2), group 208-3 (Group 3) and group 208-4 (Group 4). Thus, in accordance with one or more illustrative embodiments, data point 206 is considered more valuable than data point 202 as node n2 connects with more well-knit groups (four) than node n1 (two).

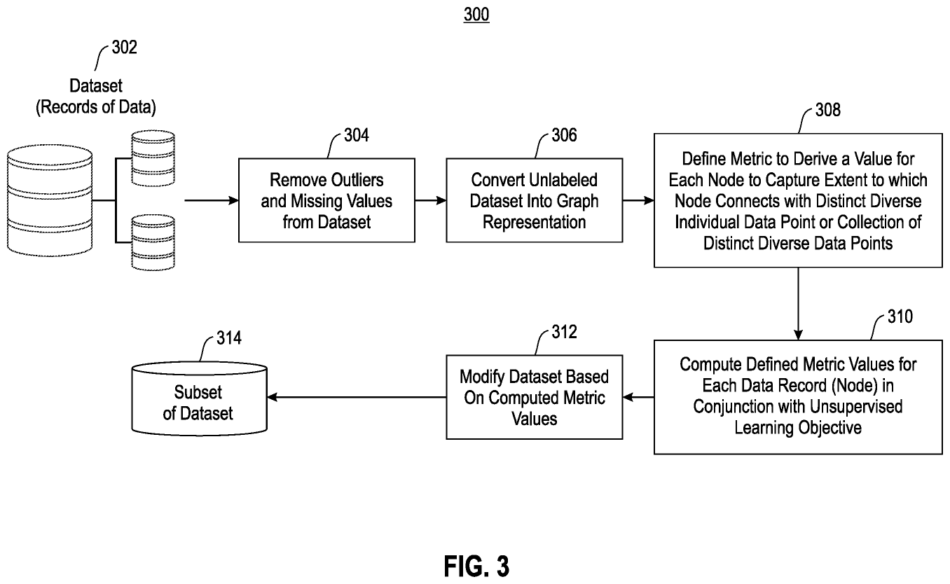

FIG. 3 depicts an unlabeled data quality assessment process flow 300 according to an illustrative embodiment. It is to be appreciated that process flow 300 can be executed, for example, by unlabeled data quality assessment engine 104 of FIG. 1. As shown, process flow 300 receives a dataset (set of data records or data points) 302. Note that dataset 302 is an unlabeled dataset, e.g., similar to unlabeled dataset 102 in FIG. 1 and as otherwise described herein. Also note that, in some embodiments, when the unlabeled data in dataset 302 is in the form of relational type (tabular) data, a given data record or data point can represent a given row in a given table.

Process flow 300 begins with step 304 which is a pre-processing step wherein outliers and incomplete data (e.g., missing data values) are removed (cleaned) from dataset 302. Specific definitions of outlier and incomplete data are dependent on the nature of the data being processed and can be set by a data scientist and/or data system managing the data.

Step 306 converts the pre-processed version of dataset 302 into a graph structure (i.e., graph). As mentioned above, using conventional graph construction techniques, each data point in dataset 302 is represented as a node (vertex) in the graph, and weighted edges are added between some or all nodes, wherein values (weights) of the weighted edges reflect the similarity between the connected nodes.

Step 308 defines a metric to derive a value for each node (data record or data point) of the graph to capture the extent to which the node connects with a node representing a distinct diverse individual data point or collections of nodes representing distinct diverse data points. Recall that in one or more illustrative embodiments, diverse refers to the degree of dissimilarity between pairs of data points, i.e., the measure of dissimilarity is above or at and below a predetermined threshold.

Step 310 computes the values for the metric defined in step 308 for each data record (node) in conjunction with at least one unsupervised learning objective. Illustrative embodiments define several metrics that can be computed to determine values for the nodes (data records of data points) representing the unlabeled dataset 302, as will be further described below.

In step 312, the resulting computed metric values are then used to prune or modify the unlabeled dataset 302 to yield a subset 314 of unlabeled dataset 302, as will be further described below. Subset 314 is then used by an unsupervised machine learning algorithm to perform one or more machine learning tasks.

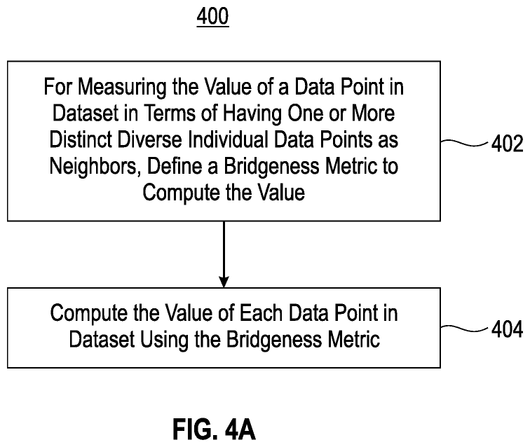

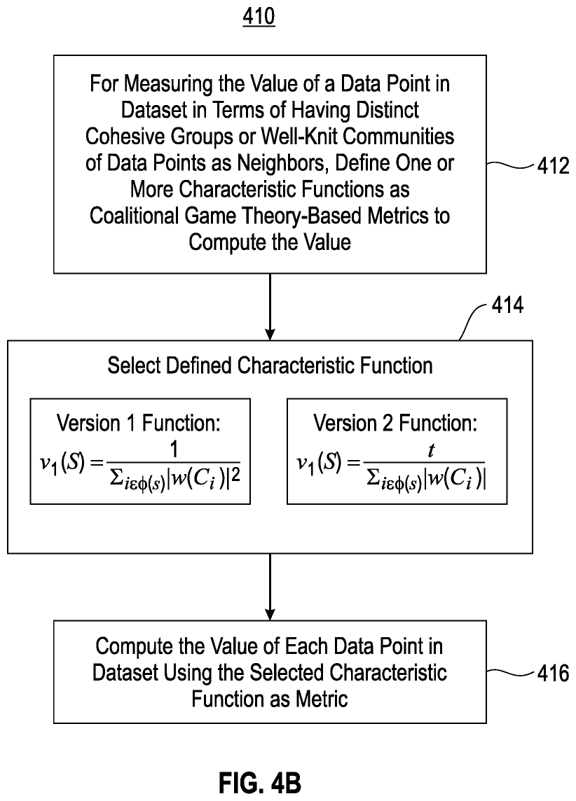

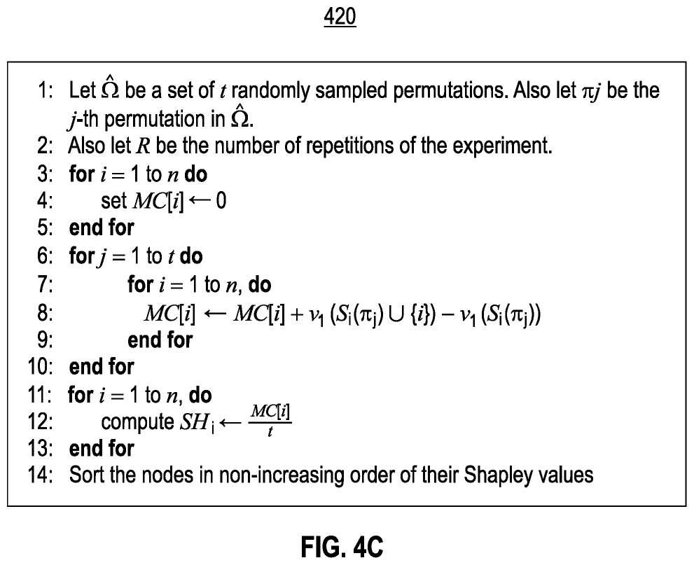

As depicted in metric definition and computation process 400 of FIG. 4A, consider the scenario wherein the value of a data point in dataset 302 is measured in terms of having one or more distinct diverse individual data points as neighbors. Recall that the notion of diverse refers to the dissimilarity between a pair of data points. However, in a graph-based model of the dataset, the weights on the edges typically refer to similarity between pairs of data points. This implies that the value of a data point is proportional to the extent the corresponding node in the graph behaves as a bridge to connect various other individual nodes. Accordingly, the process 400 in FIG. 4A defines a bridgeness of each node in the graph in step 402. By way of example only, a betweenness centrality measure is one technique to compute the bridgeness of the nodes in the graph according to an illustrative embodiment. In graph theory, betweenness centrality is a measure of centrality in a graph based on shortest paths. For every pair of nodes in a connected graph, there exists at least one shortest path between the nodes such that the sum of the weights of the edges that the path passes through is minimized. As such, the betweenness centrality for each node is the number of shortest paths that pass through the node. It is to be appreciated that alternative embodiments can utilize other definitions of bridgeness and/or betweenness, as well as other qualitative indicators. In step 404 of FIG. 4A, process 400 computes the value of each data point in dataset 302 using the bridgeness metric.

Next, as depicted in metric definition and computation process 410 of FIG. 4B, consider the scenario wherein the value of a data point in dataset 302 is measured in terms of having distinct cohesive groups (or well-knit communities) of data points in its neighborhood. Illustrative embodiments propose a coalitional game theory-based methodology to derive the value for each data point in the dataset. The set of nodes in the graph is the set of players in the coalitional game which utilizes a characteristic function. Accordingly, the process 410 in FIG. 4B defines a characteristic function as a measure of each node in the graph in step 412.

Two versions of the characteristic function are illustratively defined and one is selected in step 414. In some embodiments, more than two characteristic functions can be selected from, while in other embodiments, the characteristic function is pre-selected such that no selection is made. The intuition behind each of the two illustrative versions of the characteristic function is as follows. Consider any group of nodes, call it S⊆N, where S is the group and N are the nodes. The greater the number of cohesive groups/communities (with more sums of intra-edge weights) to which the nodes in S are connected, the higher the value of nodes in S should be. This objective is accomplished by defining the characteristic function as a function of the inverse of the sum of the intra-edge weights of these connected components.

By way of example, in the graph (call it G) of data points, the edge between each pair of data points captures how similar the two corresponding data points are to one another. That is, if a node i in G has very high similarity scores with its neighbors, then it indicates that node i is not a valuable data point to retain. On the other hand, if a node i in G has very low similarity scores with its neighbors, then it indicates that node i possesses a very different piece of information than its neighbors and thus it is a valuable data point to retain. This principle is captured by defining a value for each node. Following this value-based approach:

(a) The higher is the value for a node, the more distinct is that node as compared to its neighbors (and thereby the similarity scores of that node's neighbors are expected to be low); and

(b) The lower is the value for a node, the less distinct is that node as compared to its neighbors (and thereby the similarity scores of that node's neighbors are expected to be high).

In accordance with the above principle, two illustrative characteristic functions include:

Version 1: The first version of the characteristic function v₁(.) is defined as follows: ∀S⊆N,

$${v}_{1} ( S ) = \frac{1}{{\sum }_{i ∈ Φ ( S )} {\vert w ( {C}_{i} ) \vert}^{2}} ,$$

where w(Cᵢ) is the sum of weighted edges inside the connected component Cᵢ, Φ(S)={1, 2, . . . , t} is the set of indices for the t connected components (i. e. C₁, C₂, . . . , Cₜ) in G(N\S,E(N\S)).

Version 2: For each S⊆N, the second version of the characteristic function v₂(.) is defined as follows: ∀S⊆N,

$${v}_{2} ( S ) = \frac{t}{{\sum }_{i ∈ Φ ( S )} \vert w ( {C}_{i} ) \vert} ,$$

where w(Cᵢ) is the sum of weighted edges inside the connected component Cᵢ, Φ(S)={1, 2, . . . , t} is the set of indices for the t connected components (i. e. C₁, C₂, . . . , Cₜ) in G(N\S,E(N\S)).

The purpose of both these value functions is the same and they attach a value for each subset (S) of nodes that is proportional to the extent to which these nodes in S are connected with cohesive groups or communities. In particular, if a subset S of nodes are connected with a relatively large number of communities, then its value would be higher. Further, if a subset S of nodes are connected with a relatively smaller number of communities, then its value would be lesser. Also, intuitively, the first value function (Version 1) is aggressive in achieving this objective, whereas the later one (Version 2) is a relatively relaxed version.

In step 416 of FIG. 4B, process 410 computes the value of each data point in dataset 302 using the characteristic function selected in step 414.

In one illustrative coalitional game theory-based embodiment, as depicted in pseudocode 420 of FIG. 4C, a Shapley value-based approximation is used as a metric to compute values for data points. The Shapley value-based approximation is a method for assigning payouts to players depending on their contribution to the total payout. Players cooperate in a coalition and receive a certain profit from this cooperation. In terms of unsupervised machine learning, the game is the prediction task for a single instance of a dataset, the gain is the actual prediction for this instance minus the average prediction for all instances, and the players are the feature values of the instance that collaborate to receive the gain. In other words, the Shapley value SH in pseudocode 420 expresses how much each feature contributes to creating the overall performance and represents feature importance while maintaining consistent and locally accurate additive feature attribution for a particular prediction.

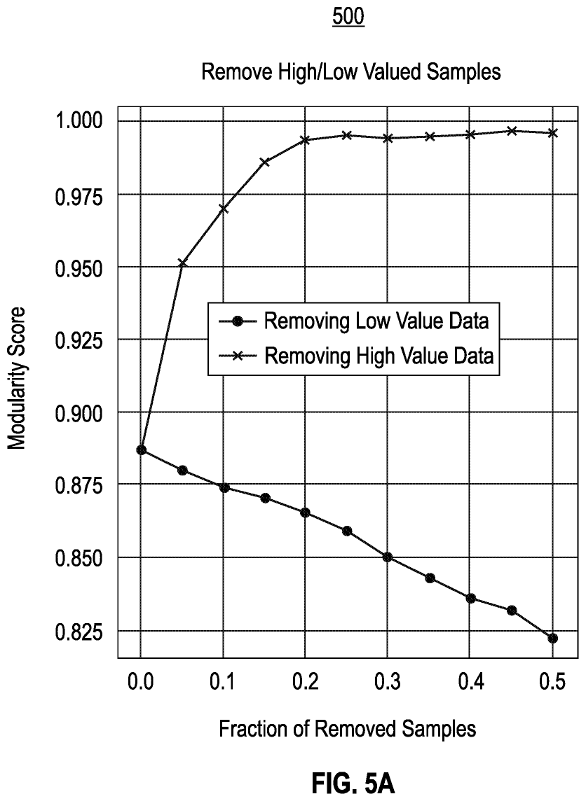

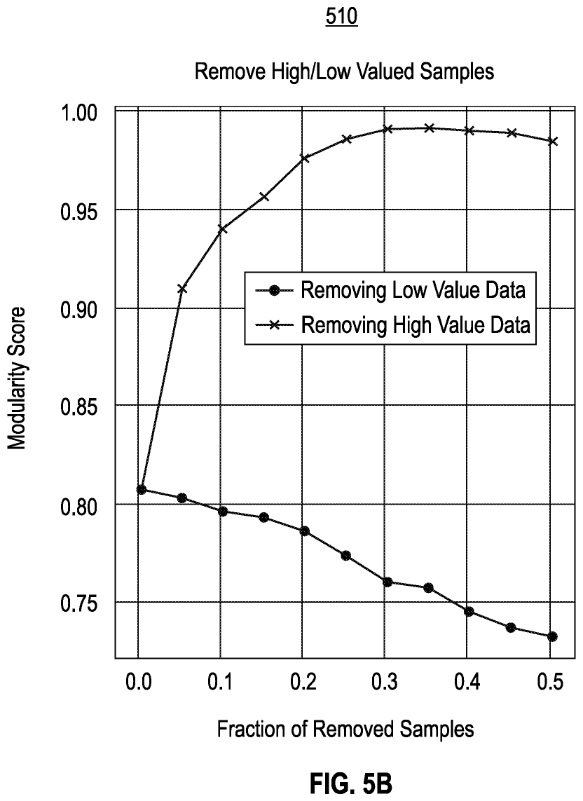

With two separate unlabeled datasets as examples, graphs 500 and 510 of FIGS. 5A and 5B respectively demonstrate that by removing high value data points, a modularity score increases significantly as the modular structure increases. Conversely, by removing low value data points, the modularity score decreases significantly as the graph coherence drops. Modularity is a measure of the structure of graphs which measures the strength of division of a graph into modules. Graph structures with high modularity have dense connections between the nodes within modules but sparse connections between nodes in different modules.

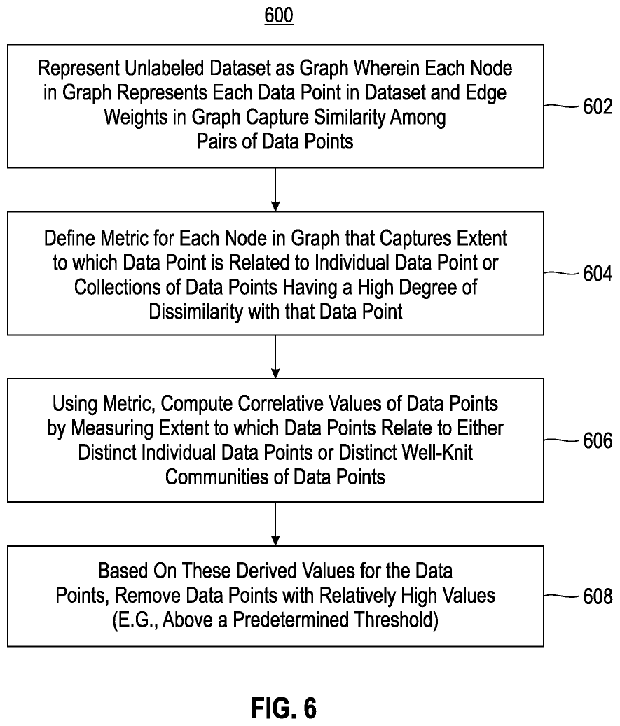

Accordingly, taking into account the above and other features described herein, FIG. 6 illustrates an unsupervised methodology 600 that is agnostic to downstream analytics and that derives a correlative quality measure for each unlabeled data point in a dataset. The correlative quality measure captures the extent of distinct dissimilar individual data points or distinct well-knit groups of similar data points in the dataset.

In step 602, an unlabeled dataset is represented as a graph wherein each node in the graph represents each data point in the dataset and edge weights in the graph capture similarity among the pairs of data points.

In step 604, a metric is defined for each node in the graph that captures the extent to which the data point is related to an individual data point or collections of data points having a high degree of dissimilarity with that data point.

In step 606, the defined metric is used to compute correlative values of the data points by measuring the extent to which data points relate to either distinct individual data points or distinct well-knit communities of data points.

In step 608, based on these derived values for the data points, data points with relatively high values (e.g., above a predetermined threshold) are removed. As such, the effectiveness (in terms of a performance measure) of the unsupervised learning objective increases. In contrast, when the data points having relatively low values (e.g., at or below the predetermined threshold) are removed, the effectiveness of the unsupervised learning objective decreases.

In some embodiments, the graph can represent an egonet. An egonet or egocentric network is a collection of egocentric social network data (e.g., all social network data of a website on the Internet) which can be analyzed to provide general global network measures and data matrixes that can be used for further analysis and presented to users in a useful manner.

The techniques depicted in FIGS. 1-6 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIGS. 1-6 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

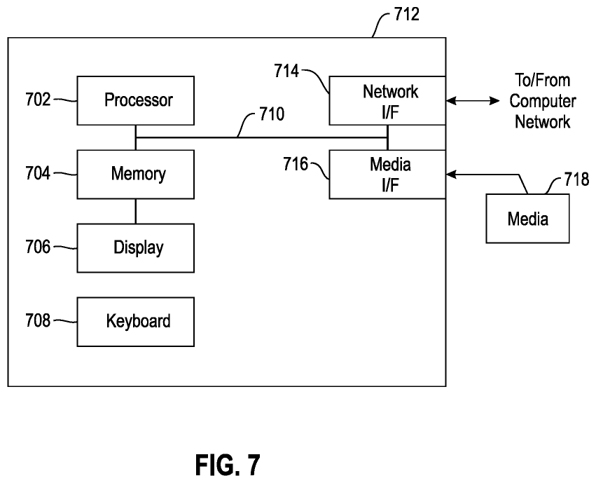

Additionally, an embodiment of the present invention can make use of software running on a computer or workstation. With reference to FIG. 7, such an implementation might employ, for example, a processor 702, a memory 704, and an input/output interface formed, for example, by a display 706 and a keyboard 708. The term “processor” as used herein is intended to include any processing device, such as, for example, one that includes a multi-core CPU, GPU, FPGA and/or other forms of processing circuitry such as one or more ASICs. Further, the term “processor” may refer to more than one individual processor. The term “memory” is intended to include memory associated with a processor (e.g., CPU, GPU, FPGA, ASIC, etc.) such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Accordingly, computer software including instructions or code for performing the methodologies of embodiments of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 702 coupled directly or indirectly to memory elements 704 through a system bus 710. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 702. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICs), functional circuitry, an appropriately programmed digital computer with associated memory, and the like. Given the teachings of the invention provided herein, one of ordinary skill in the related art will be able to contemplate other implementations of the components of the invention.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

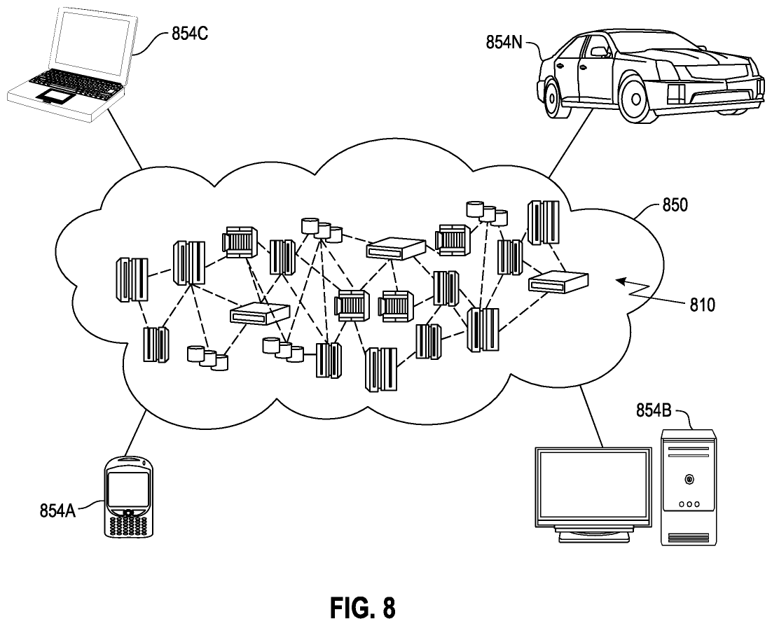

Referring now to FIG. 8, illustrative cloud computing environment 850 is depicted. As shown, cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

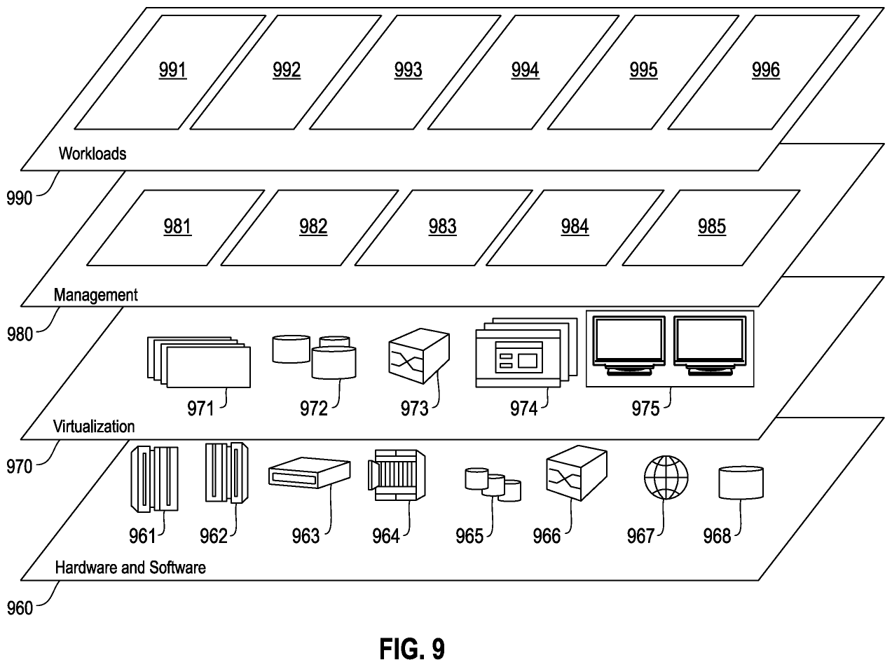

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 includes hardware and software components. Examples of hardware components include: mainframes 961; RISC (Reduced Instruction Set Computer) architecture-based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975. In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and unsupervised machine learning algorithm processing 996, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, a framework (e.g., a set of one or more framework configurations) that replaces the complex manual (e.g., custom-built) development of model restoration logic. As illustratively described herein, the framework is configured and instantiated with a set of failure detection components and associated model restoration pipelines. Once instantiated, the framework plugs into a given lifecycle using logs as inputs and delivers new model artifacts for a new model version into the existing lifecycle pipelines. In one or more illustrative embodiments, the framework is a cloud-based framework and platform for end-to-end development and lifecycle management of AI applications.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
at least one processing device comprising a processor coupled to a memory, the at least one processing device, when executing program code, is configured to:
convert a dataset of unlabeled data points into a graph structure, wherein nodes of the graph structure represent the unlabeled data points in the dataset and weighted edges between at least a portion of the nodes represent similarity between the unlabeled data points represented by the nodes;
compute a metric for each node of the graph structure, wherein a value generated by the metric for a given node represents a measure of dissimilarity between the corresponding unlabeled data point of the given node and one or more other unlabeled data points of one or more other nodes; and
generate a subset of the dataset by removing one or more unlabeled data points from the dataset based on one or more values of the computed metric.

2. The apparatus of claim 1, wherein the at least one processing device, when executing program code, is further configured to utilize the subset of the dataset in accordance with an unsupervised machine learning algorithm.

3. The apparatus of claim 1, wherein the metric comprises a measure of an extent to which a given node corresponding to an unlabeled data point relates to a neighboring node corresponding to a diverse data point.

4. The apparatus of claim 3, wherein the measure of the extent to which a given node corresponding to an unlabeled data point relates to a neighboring node corresponding to a diverse data point comprises a bridgeness metric.

5. The apparatus of claim 1, wherein the metric comprises a measure of an extent to which a given node corresponding to an unlabeled data point relates to a collection of neighboring nodes respectively corresponding to diverse data points.

6. The apparatus of claim 5, wherein the measure of the extent to which a given node corresponding to an unlabeled data point relates to a collection of neighboring nodes respectively corresponding to diverse data points comprises a coalitional game theory-based metric.

7. The apparatus of claim 6, wherein the coalitional game theory-based metric comprises a Shapley value approximation.

8. The apparatus of claim 1, wherein the at least one processing device, when executing program code, is further configured to pre-process the dataset of unlabeled data points prior to the conversion to the graph structure.

9. The apparatus of claim 8, wherein the pre-processing comprises removing one or more of any outliers and any incomplete data from the dataset of unlabeled data points.

10. A method comprising:
converting a dataset of unlabeled data points into a graph structure, wherein nodes of the graph structure represent the unlabeled data points in the dataset and weighted edges between at least a portion of the nodes represent similarity between the unlabeled data points represented by the nodes;
computing a metric for each node of the graph structure, wherein a value generated by the metric for a given node represents a measure of dissimilarity between the corresponding unlabeled data point of the given node and one or more other unlabeled data points of one or more other nodes; and
generating a subset of the dataset by removing one or more unlabeled data points from the dataset based on one or more values of the computed metric;
wherein the steps are performed by at least one processing device comprising a processor coupled to a memory when executing program code.

11. The method of claim 10, further comprising utilizing the subset of the dataset in accordance with an unsupervised machine learning algorithm.

12. The method of claim 10, wherein the metric comprises a measure of an extent to which a given node corresponding to an unlabeled data point relates to a neighboring node corresponding to a diverse data point.

13. The method of claim 12, wherein the measure of the extent to which a given node corresponding to an unlabeled data point relates to a neighboring node corresponding to a diverse data point comprises a bridgeness metric.

14. The method of claim 10, wherein the metric comprises a measure of an extent to which a given node corresponding to an unlabeled data point relates to a collection of neighboring nodes respectively corresponding to diverse data points.

15. The method of claim 14, wherein the measure of the extent to which a given node corresponding to an unlabeled data point relates to a collection of neighboring nodes respectively corresponding to diverse data points comprises a coalitional game theory-based metric.

16. The method of claim 15, wherein the coalitional game theory-based metric comprises a Shapley value approximation.

17. A computer program product comprising a processor-readable storage medium having encoded therein executable code of one or more software programs, wherein the one or more software programs when executed by the one or more processors implement steps of:
converting a dataset of unlabeled data points into a graph structure, wherein nodes of the graph structure represent the unlabeled data points in the dataset and weighted edges between at least a portion of the nodes represent similarity between the unlabeled data points represented by the nodes;
computing a metric for each node of the graph structure, wherein a value generated by the metric for a given node represents a measure of dissimilarity between the corresponding unlabeled data point of the given node and one or more other unlabeled data points of one or more other nodes; and
generating a subset of the dataset by removing one or more unlabeled data points from the dataset based on one or more values of the computed metric.

18. The computer program product of claim 17, further comprising utilizing the subset of the dataset in accordance with an unsupervised machine learning algorithm.

19. The computer program product of claim 17, wherein the metric comprises a measure of an extent to which a given node corresponding to an unlabeled data point relates to a neighboring node corresponding to a diverse data point.

20. The computer program product of claim 17, wherein the metric comprises a measure of an extent to which a given node corresponding to an unlabeled data point relates to a collection of neighboring nodes respectively corresponding to diverse data points.
